(19) United States
(12) Patent Application Publication
(10) Pub. No.: US 2021/0165825 A1
(43) Pub. Date: Jun. 3, 2021

(54) INFORMATION PROCESSING APPARATUS, INFORMATION PROCESSING METHOD, AND PROGRAM

(71) Applicant: Sony Corporation, Tokyo (JP)

(72) Inventors: Yoshiki Tanaka, Kanagawa (JP); Kuniaki Torii, Tokyo (JP)

(73) Assignee: Sony Corporation, Tokyo (JP)

(21) Appl. No.: 17/048,537

(22) PCT Filed: Feb. 15, 2019
(86) PCT No.: PCT/JP2019/005519

§ 371 Date: Oct. 16, 2020

(30) Foreign Application Priority Data
Apr. 25, 2018 (JP) 2018-083863

(51) Int. Cl. G06F 16/632; G10L 15/22; G06F 3/14; G10L 15/08; G06F 16/61

(52) U.S. Cl. CPC G06F 16/634; G10L 15/22; G06F 16/61; G10L 15/08; G06F 3/14

(57) ABSTRACT

An information processing apparatus, including: a control unit configured to perform, when there are a plurality of pieces of information corresponding to a predetermined term having been associated with a plurality of pieces of attribute information as candidates of a search result, control to notify each piece of information by making an index calculated with respect to each term recognizable.

### TECHNICAL FIELD

The present disclosure relates to an information processing apparatus, an information processing method, and a program.

### BACKGROUND ART

An electronic device referred to as an agent that provides information in accordance with a spoken request is proposed (for example, refer to PTL 1).

### CITATION LIST

### Patent Literature

[PTL 1]

JP 2008-90545A

### SUMMARY

### Technical Problem

In such a field, usability improves if, when an ambiguous utterance is made by a user, the user is able to recognize an index (a criterion) based on which a determination of information corresponding to the ambiguous utterance had been made.

An object of the present disclosure is to provide an information processing apparatus, an information processing method, and a program which, for example, when there are a plurality of pieces of information based on a search result, notifies the pieces of information by making an index corresponding to each piece of information recognizable.

### Solution to Problem

The present disclosure is, for example,

an information processing apparatus including:

a control unit configured to perform, when there are a plurality of pieces of information corresponding to a predetermined term having been associated with a plurality of pieces of attribute information as candidates of a search result, control to notify each piece of information by making an index calculated with respect to each term recognizable.

The present disclosure is, for example,

an information processing method including:

a control unit performing, when there are a plurality of pieces of information corresponding to a predetermined term having been associated with a plurality of pieces of attribute information as candidates of a search result, control to notify each piece of information by making an index calculated with respect to each term recognizable.

The present disclosure is, for example,

a program that causes a computer to execute an information processing method including:

a control unit performing, when there are a plurality of pieces of information corresponding to a predetermined term having been associated with a plurality of pieces of attribute information as candidates of a search result, control to notify each piece of information by making an index calculated with respect to each term recognizable.

### Advantageous Effects of Invention

According to at least one embodiment of the present disclosure, when a plurality of pieces of information are notified, a user can recognize indices corresponding to the pieces of information. It should be noted that the advantageous effect described above is not necessarily restrictive and any of the advantageous effects described in the present disclosure may apply. In addition, it is to be understood that contents of the present disclosure are not to be interpreted in a limited manner according to the exemplified advantageous effects.

### BRIEF DESCRIPTION OF DRAWINGS

FIG. 1 is a block diagram showing a configuration example of an agent according to an embodiment.

FIG. 2 is a diagram for explaining functions of a control unit according to a first embodiment.

FIG. 3 is a diagram showing an example of information stored in a database according to the first embodiment.

FIG. 4 is a diagram showing an example of accuracy scores and subscores according to the first embodiment.

FIG. 5 is a diagram for explaining an example of communication that takes place between a user and an agent.

FIG. 6 is a diagram for explaining an example of communication that takes place between a user and an agent.

FIG. 7 is a diagram for explaining an example of communication that takes place between a user and an agent.

FIG. 8 is a diagram for explaining an example of communication that takes place between a user and an agent.

FIG. 9 is a diagram for explaining an example of communication that takes place between a user and an agent.

FIG. 10 is a diagram for explaining an example of communication that takes place between a user and an agent.

FIG. 11 is a diagram for explaining an example of communication that takes place between a user and an agent.

FIG. 12 is a flow chart showing a flow of processing performed in the first embodiment.

FIG. 13 is a flow chart showing a flow of processing performed in the first embodiment.

FIG. 14 is a diagram for explaining functions of a control unit according to a second embodiment.

FIG. 15 is a diagram to be referred to for explaining a specific example of information stored in a database according to the second embodiment.

FIG. 16 is a diagram showing an example of accuracy scores and subscores according to the second embodiment.

FIG. 17 is a diagram for explaining functions of a control unit according to a third embodiment.

FIG. 18 is a diagram showing an example of information stored in a database according to the third embodiment.

FIG. 19 is a diagram showing an example of accuracy scores and subscores according to the third embodiment.

FIG. 20 is a diagram for explaining a modification.

### DESCRIPTION OF EMBODIMENTS

Hereinafter, embodiments and the like of the present disclosure will be described with reference to the drawings. The description will be given in the following order.

### <First Embodiment>

### <Second Embodiment>

### <Third Embodiment>

### <Modifications>

It is to be understood that the embodiments and the like described below are preferable specific examples of the present disclosure and that contents of the present disclosure are not to be limited to such embodiments and the like.

### First Embodiment

### Configuration Example of Agent

In the embodiment, an agent will be described as an example of an information processing apparatus. An agent according to the embodiment signifies, for example, a speech input/output apparatus of which a size is more or less portable or a spoken dialogue function with a user that is included in such an apparatus. Such an agent may also be referred to as a smart speaker or the like. It is needless to say that the agent is not limited to a smart speaker and may be a robot or the like or, alternatively, the agent itself may not be independent and may be built into various electronic devices such as smart phones, vehicle-mounted equipment, or home electrical appliances.

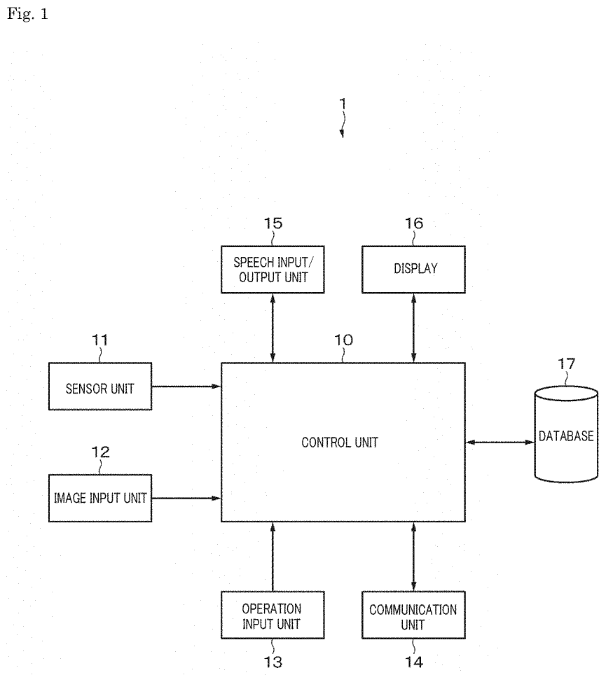

FIG. 1 is a block diagram showing a configuration example of an agent (an agent 1) according to a first embodiment. The agent 1 has, for example, a control unit 10, a sensor unit 11, an image input unit 12, an operation input unit 13, a communication unit 14, a speech input/output unit 15, a display 16, and a database 17.

The control unit 10 is constituted by a CPU (Central Processing Unit) or the like and controls the respective units of the agent 1. The control unit 10 has a ROM (Read Only Memory) that stores a program and a RAM (Random Access Memory) to be used as a work memory when the control unit 10 executes the program (it should be noted that the ROM and the RAM are not illustrated). The control unit 10 performs, when there are a plurality of pieces of information corresponding to a predetermined term having been associated with a plurality of pieces of attribute information as candidates of a search result, control to notify each piece of information by making an index calculated with respect to each term recognizable. Specific examples of control to be performed by the control unit 10 will be described later.

The sensor unit 11 is, for example, a sensor apparatus capable of acquiring biological information of a user of the agent 1. Examples of biological information include a fingerprint, blood pressure, a pulse, a sweat gland (a position of the sweat gland or a degree of perspiration from the sweat gland may suffice), and a body temperature of the user. It is needless to say that, alternatively, the sensor unit 11 may be a sensor apparatus (for example, a GPS (Global Positioning System) sensor or a gravity sensor) that acquires information other than biological information. Sensor information obtained by the sensor unit 11 is input to the control unit 10.

The image input unit 12 is an interface that accepts image data (which may be still image data or moving image data) input from the outside. For example, image data is input to the image input unit 12 from an imaging apparatus or the like that differs from the agent 1. The image data input to the image input unit 12 is input to the control unit 10. Alternatively, image data may be input to the agent 1 via the communication unit 14, in which case the image input unit 12 need not be provided.

The operation input unit 13 is for accepting an operation input from the user. Examples of the operation input unit 13 include a button, a lever, a switch, a touch panel, a microphone, and an eye-gaze tracking device. The operation input unit 13 generates an operation signal in accordance with an input made to the operation input unit 13 itself and supplies the operation signal to the control unit 10. The control unit 10 executes processing in accordance with the operation signal.

The communication unit 14 communicates with other apparatuses that are connected via a network such as the Internet. The communication unit 14 has components such as a modulation/demodulation circuit and an antenna which correspond to a communication standard. Communication performed by the communication unit 14 may be wired communication or wireless communication. Examples of wireless communication include a LAN (Local Area Network), Bluetooth (registered trademark), Wi-Fi (registered trademark), and WUSB (Wireless USB). The agent 1 is capable of acquiring various types of information from a connection destination of the communication unit 14.

The speech input/output unit 15 is a component that inputs speech to the agent 1 and a component that outputs speech to the user. An example of the component that inputs speech to the agent 1 is a microphone. In addition, an example of the component that outputs speech to the user is a speaker apparatus. For example, an utterance by the user is input to the speech input/output unit 15. The utterance input to the speech input/output unit 15 is supplied to the control unit 10 as utterance information. In addition, in accordance with control by the control unit 10, the speech input/output unit 15 reproduces predetermined speech with respect to the user. When the agent 1 is portable, carrying around the agent 1 enables speech to be input and output at any location.

The display 16 is a component that displays still images and moving images. Examples of the display 16 include an LCD (Liquid Crystal Display), organic EL (Electro Luminescence), and a projector. The display 16 according to the embodiment is configured as a touch screen and enables operation input by coming into contact with (or coming close to) the display 16.

The database 17 is a storage unit that stores various types of information. Examples of the database 17 include a magnetic storage device such as an HDD (Hard Disk Drive), a semiconductor storage device, an optical storage device, and a magneto-optical storage device. Predetermined information among information stored in the database 17 is searched by the control unit 10 and a search result thereof is presented to the user.

The agent 1 may be configured to be driven based on power supplied from a commercial power supply or may be configured to be driven based on power supplied from a chargeable and dischargeable lithium-ion secondary battery or the like.

While a configuration example of the agent 1 has been described above, the configuration of the agent 1 can be modified as deemed appropriate. In other words, a configuration of the agent 1 may not include a part of the illustrated components or may differ from the illustrated configuration.

### Functions of Agent

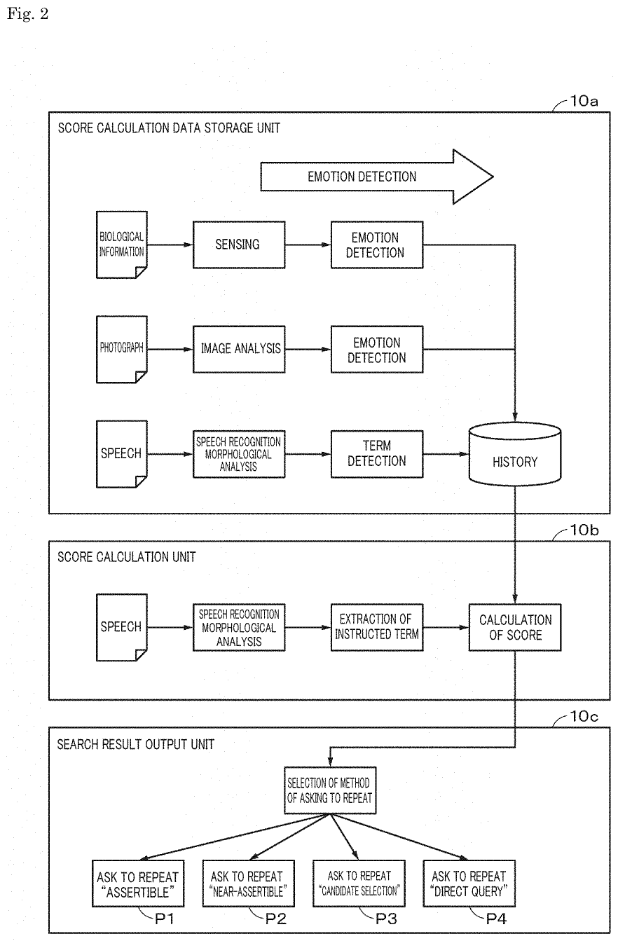

Next, functions of the agent 1 and, more specifically, an example of functions of the control unit 10 will be described with reference to FIG. 2. As functions thereof, for example, the control unit 10 has a score calculation data storage unit 10a, a score calculation unit 10b, and a search result output unit 10c.

### Score Calculation Data Storage Unit

The score calculation data storage unit 10a stores information in the database 17. As shown in FIG. 2, the score calculation data storage unit 10a detects emotion based on a sensing result of biological information obtained via the sensor unit 11, a result of image analysis with respect to image data of a photograph or the like that is input from the image input unit 12, a result of speech recognition, and the like. In addition, the score calculation data storage unit 10a performs speech recognition and morphological analysis with respect to utterance information that is input via the speech input/output unit 15, associates a result thereof and a result of emotion detection and the like with each other, and stores the associated result in the database 17 as history.

According to the result of speech recognition and morphological analysis performed by the score calculation data storage unit 10a, for example, the following is obtained: a predetermined term (for example, a noun); related terminology that is related to the term (for example, a noun in apposition to the term, an adjective that modifies the term, and a verb with respect to the term); time-of-day information included in an utterance (which may be a time of day itself or information equivalent to a time of day); positional information included in an utterance (for example, a geographical name, an address, and latitude and longitude); and an identification score (a score value according to a recognition likelihood of speech recognition).

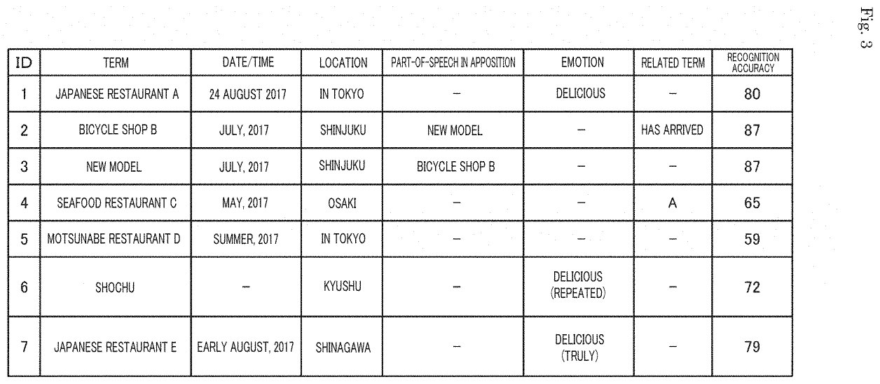

FIG. 3 shows an example of information stored in the database 17 by the score calculation data storage unit 10a. The database 17 stores predetermined terms associated with a plurality of pieces of attribute information. In FIG. 3, “ID”, “time of day”, “location”, “part-of-speech in apposition”, “emotion”, “related term”, and “recognition accuracy” are shown as examples of attribute information.

For example, an utterance of

“The food at Japanese restaurant A that we went to last week (24 Aug. 2017) was delicious”

is input to the speech input/output unit 15.

In this case, the score calculation data storage unit 10a sets “Japanese restaurant A” as a term corresponding to ID: 1 and stores attribute information obtained based on utterance information in association with “Japanese restaurant A”. For example, with respect to “Japanese restaurant A”, the score calculation data storage unit 10a associates and stores “24 Aug. 2017” as the time of day, “in Tokyo” as the location, “delicious” as the emotion, and “80” as recognition accuracy. When a location is not included in the utterance information, for example, the agent 1 acquires a log (for example, a log stored in a smart phone or the like) of positional information on “24 Aug. 2017” and registers the acquired positional information as the location. The recognition accuracy is a value that is set in accordance with a magnitude of noise or the like at the time of speech recognition.

For example, an utterance of

“I've heard a new model has arrived at Bicycle shop B which I told you about last month (July, 2017)”

is input to the speech input/output unit 15.

In this case, the score calculation data storage unit 10a extracts “Bicycle shop B” and “new model” that are included in utterance information, sets attribute information corresponding to each term, and stores the terms and the set attribute information in the database 17. In FIG. 3, ID: 2 represents an example of a term “Bicycle shop B” and attribute information that corresponds to the term, and ID: 3 represents an example of a term “new model” and attribute information that corresponds to the term. For example, the agent 1 controls the communication unit 14 and accesses Bicycle shop B's website, acquires detailed location thereof (in the example shown in FIG. 3, “Shinjuku”), and registers the acquired location information as a location corresponding to “Bicycle shop B”.

ID: 4 represents

an example of a term and attribute information corresponding to the term that are stored in the database 17 based on utterance information of

“I met A at Seafood restaurant C that we went to last month (May, 2017)”.

ID: 5 represents

an example of a term and attribute information corresponding to the term that are stored in the database 17 based on utterance information of

“Motsunabe restaurant D in Osaki which we visited in summer has reopened”.

As in the present example, there are also cases where a “location” that is positional information is acquired based on utterance information.

ID: 6 represents

an example of a term and attribute information corresponding to the term that are stored in the database 17 based on utterance information of

“I want to find that wonderful, wonderful shochu that we had during our trip to Kyushu”.

As an emotion, the fact that “wonderful” is repeated is also stored.

ID: 7 represents

an example of a term and attribute information corresponding to the term that are stored in the database 17 based on utterance information of

“I want to revisit Japanese restaurant E where we went to in early August and the food was truly delicious”.

As an emotion, the fact that the term “truly” is added to emphasize “delicious” is also stored.

It is needless to say that the contents of the database 17 shown in FIG. 3 are simply an example and the database 17 is not limited thereto. Other pieces of information may also be used as attribute information.

### Score Calculation Unit

The score calculation unit 10b calculates a score that is an index with respect to information stored in the database 17. A score according to the present embodiment includes a subscore that is calculated for each piece of attribute information and an integrated score that integrates subscores. An integrated score is, for example, a simple addition or a weighted addition of subscores. In the following description, an integrated score will be referred to as an accuracy score when appropriate.

As shown in FIG. 2, for example, when utterance information is input via the speech input/output unit 15, the control unit 10 always performs speech recognition and morphological analysis with respect to the utterance information. In addition, when utterance information including a term with ambiguity is input, the control unit 10 calculates an accuracy score and a subscore that correspond to the utterance information for each term that is stored in the database 17. A term with ambiguity is a term which refers to something but it is impossible to uniquely identify exactly what the term refers to. Specific examples of a term with ambiguity include demonstratives such as that and it, terms including temporal ambiguity such as recently, and terms including locational ambiguity such as near or around P station. A term with ambiguity is extracted using, for example, meta-information related to context.

For example, let us consider a case where a request from a user of

“Make a reservation at that restaurant where I recently visited and where the food was delicious”

was input to the agent 1 by speech at Osaki Station on 10 Sep. 2017.

Since the utterance information include a term with ambiguity (in the present example, the term “recently”), the score calculation unit 10b calculates an accuracy score and a subscore. It should be noted that an upper limit value, a lower limit value, and the like of the accuracy score and the subscore can be appropriately set.

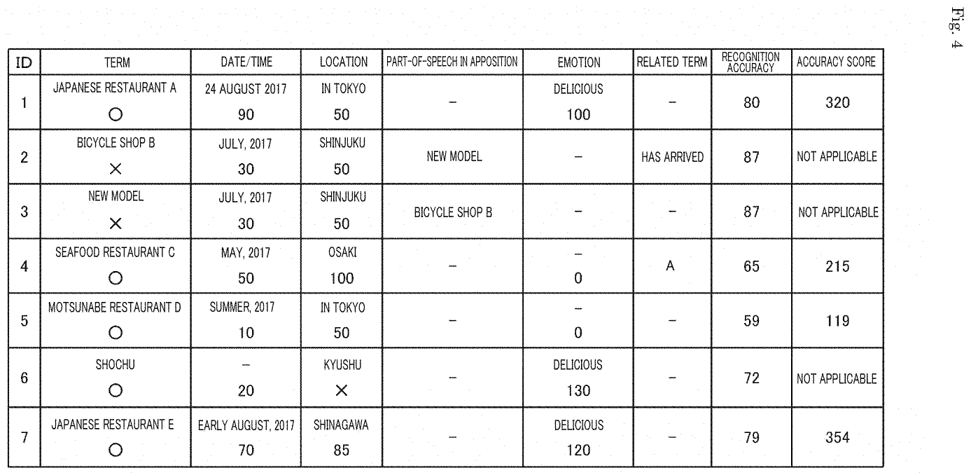

FIG. 4 is a diagram showing an example of accuracy scores and subscores. Since contents of the utterance information are “a restaurant where the food was delicious”, pieces of information on places other than restaurants (in the example shown in FIG. 4, pieces of information corresponding to ID: 2 and ID: 3) are excluded. In this case, accuracy scores with respect to ID: 2 and ID: 3 may not be calculated or may be set to 0.

For example, the subscore for each piece of attribute information is calculated as follows.
In the case of “time of day”, attribute information that is closer to the “time of day” and of which a range is narrower (attribute information with a smaller deviation from the time of day specified in the utterance information) is given a higher score.
Similarly, in the case of “location”, attribute information that is closer to the location and of which a range is narrower (attribute information with a smaller deviation from the location specified in the utterance information) is given a higher score.
In the case of “emotion”, when there is a term indicating information on positivity/ negativity of an emotion, a basic score value is given, and when there is a term that further emphasizes the emotion (for example, “truly”) or when the emotion is repeated, a score is calculated so as to increase an absolute value of the basic score.
“Recognition accuracy” is calculated based on recognition accuracy when stored in the database 17.
Even when attribute information is not registered, a constant value is assigned without exempting the attribute information. For example, even though a time of day corresponding to ID: 6 is not registered, since it is unclear as to whether the time of day corresponding to ID: 6 is near to or far from the time of day specified in the utterance information, a certain value (for example, 20) is given.

For example, the score calculation unit 10b calculates the accuracy score by simply adding up the subscores. A specific description will be given using information corresponding to ID: 1. Since the term corresponding to ID: 1 is “Japanese restaurant A”, the term becomes a candidate of a search result. With respect to the attribute information “time of day”, since the attribute information “time of day” is near the time of day (10 Sep. 2017) that is included in the utterance information, a high score (for example, 90) is given. With respect to the attribute information “location”, although Osaki Station that is included in the utterance information is in Tokyo, since a case where the deviation is large is also assumed, an intermediate value (for example, 50) is assigned. With respect to the attribute information “emotion”, since the attribute information “emotion” has a high degree of coincidence with the emotional expression “delicious” that is included in the utterance information, a high score (for example, 100) is given. With respect to recognition accuracy, a value thereof is used as a subscore. A value obtained by a simple addition of the respective subscores, 320, is the accuracy score corresponding to the term “Japanese restaurant A”. An accuracy score and subscores are similarly calculated with respect to pieces of information corresponding to the other IDs.

It should be noted that, in the present embodiment, with respect to pieces of attribute information (part-of-speech in apposition, related term, and the like) that are often not assigned, a subscore is not calculated. Accordingly, processing can be simplified. It is needless to say that, alternatively, subscores may be calculated with respect to all of the pieces of attribute information.

### Search Result Output Unit

The search result output unit 10c outputs a search result in accordance with a score calculation result by the score calculation unit 10b. When utterance information including a term with ambiguity is input, the search result output unit 10c notifies the user of a search result. The search result output unit 10c outputs a search result in four patterns (patterns P1, P2, P3, and P4). The four patterns will be described using the example shown in FIG. 4.

While conditions corresponding to the respective patterns may overlap with each other in order to facilitate understanding of each pattern in the description below, in reality, the conditions are appropriately set so as not to overlap with each other.

### Output Examples of Search Result

### Pattern P1

The pattern P1 is an output pattern of a search result that is performed in a case where it is clearly determined that there is only one piece of information (option) that corresponds to utterance information. A case where it is clearly determined that there is only one option is, for example, a case where an accuracy score of information corresponding to a given ID exceeds a threshold and there is one piece of information of which an accuracy score exceeds the threshold.

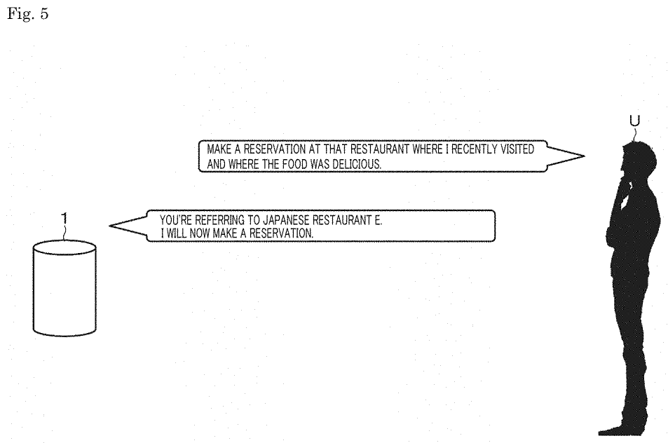

FIG. 5 is a diagram showing an example of communication that takes place between a user U and the agent 1 in the case of the pattern P1. As in the example described above, the user U makes an utterance of “Make a reservation at that restaurant where I recently visited and where the food was delicious” to the agent 1. As a result of calculating an accuracy score and subscores, since an accuracy score of “Japanese restaurant E” exceeds a threshold (for example, 330) and “Japanese restaurant E” is the only term that exceeds the threshold, the agent 1 outputs “Japanese restaurant E” that is a search result in the pattern P1.

In the case of the pattern P1, while the agent 1 notifies the user U of the one and only candidate, the agent 1 performs processing based on the utterance without questioning whether the candidate is correct or not. The control unit 10 of the agent 1 performs control of generating speech data saying “You're referring to Japanese restaurant E. I will now make a reservation.” and reproducing the speech from the speech input/output unit 15. In addition, by controlling the communication unit 14, the control unit 10 of the agent 1 accesses a website or the like of “Japanese restaurant E” to perform appropriate reservation processing.

### Pattern P2

The pattern P2 is an output pattern of a search result that is performed in a case where it is determined that there is only one piece of information (option) that corresponds to utterance information and it is determined that correctness of the piece of information (option) is around a certain degree (for example, around 90%). For example, when an accuracy score of information corresponding to a given ID exceeds a threshold (for example, 300), there is one piece of information of which an accuracy score exceeds the threshold, and a difference between the accuracy score and the threshold is within a predetermined range, a correctness of 90% is determined.

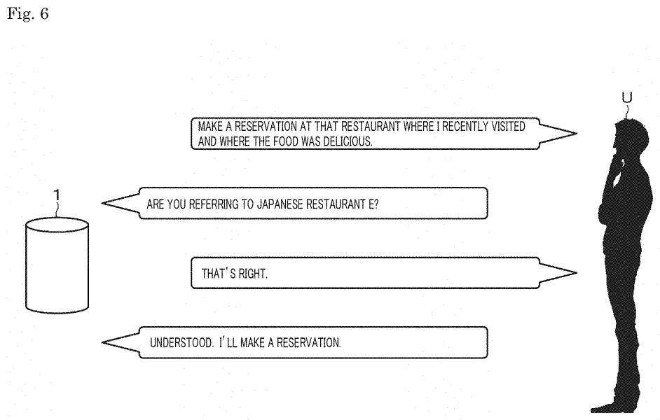

FIG. 6 is a diagram showing an example of communication that takes place between the user U and the agent 1 in the case of the pattern P2. As in the example described above, the user U makes an utterance of “make a reservation at that restaurant where I recently visited and where the food was delicious” to the agent 1. As a result of calculating an accuracy score and subscores, since an accuracy score of “Japanese restaurant E” exceeds a threshold (for example, 330) and, although “Japanese restaurant E” is the only term that exceeds the threshold, since a difference between the accuracy score and the threshold is within a predetermined range (for example, 40 or lower), the agent 1 outputs “Japanese restaurant E” that is a search result in the pattern P2.

In the case of the pattern P2, as the agent 1 notifies the user U of the one and only candidate, the agent 1 performs an interaction for confirming whether the candidate is correct or not. With respect to the utterance by the user U, the control unit 10 of the agent 1 performs control of generating speech data saying “Are you referring to Japanese restaurant E?” and reproducing the speech from the speech input/output unit 15. At this point, when confirmation by the user U is obtained in the form of a response saying “That's right” or the like, the control unit 10 of the agent 1 accesses the website or the like of “Japanese restaurant E” by controlling the communication unit 14 to perform appropriate reservation processing. When the intention of the user U is not “Japanese restaurant E”, information corresponding to a next highest accuracy score may be notified.

### Pattern P3

The pattern P3 is an output pattern of a search result that is performed in a case where, while the accuracy score of a piece of information (option) that corresponds to utterance information is sufficient, it is determined that the score is near an accuracy score of a next-highest or subsequent candidate, there are a plurality of pieces of information (options) of which the accuracy score exceeds a threshold, or the like. In the case of the pattern P3, a plurality of candidates are output as search results. Conceivable methods of outputting the search results include a method using video and a method using speech. First, the method using video will be described.

### Pattern P3: Output Example of Plurality of Search Results by Video

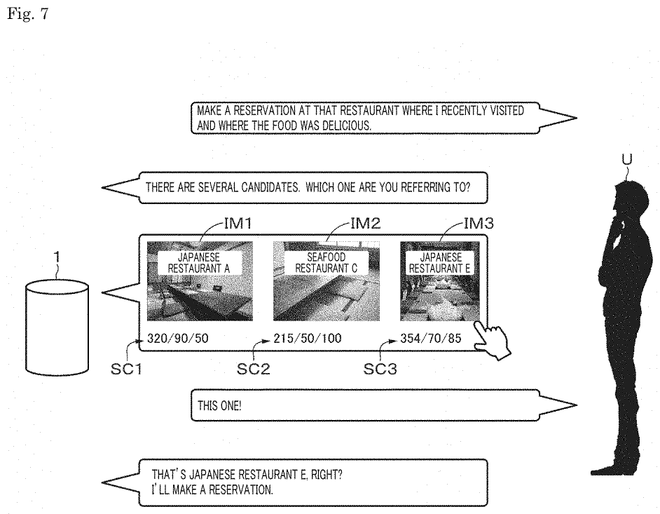

FIG. 7 is a diagram showing an example of communication that takes place between the user U and the agent 1 in the case of the pattern P3. In accordance with an utterance by the user U, the score calculation unit 10b of the control unit 10 calculates an accuracy score and subscores. Referring to the example shown in FIG. 4, while the highest accuracy score is 354 (piece of information corresponding to ID: 7), there are two pieces of information (pieces of information corresponding to ID: 1 and ID: 4) of which a difference in accuracy scores is within a threshold (for example, 150). In this case, the control unit 10 outputs pieces of information corresponding to IDs: 1, 4 and 7 as an output of search results. For example, as shown in FIG. 7, search results are output together with speech saying “There are several candidate. Which one is correct?” In the present example, still images corresponding to the plurality of candidates are displayed on the display 16. The still images corresponding to the plurality of candidates may be acquired via the communication unit 14 or may be input by the user U via the image input unit 12.

As shown in FIG. 7, an image IM1 showing “Japanese restaurant A”, an image IM2 showing “Seafood restaurant C”, and an image IM3 showing “Japanese restaurant E” are displayed on the display 16. In this case, the images IM1 to IM3 are examples of pieces of information corresponding to predetermined terms. Furthermore, each image is displayed in association with an accuracy score and subscores corresponding to each image or, more specifically, an accuracy score and subscores corresponding to each term with the ID: 1, 4, or 7. In other words, the images IM1 to IM3 are notified in such a manner that the accuracy scores and subscores having been calculated with respect to the terms corresponding to the images IM1 to IM3 are recognizable.

Specifically, an accuracy score “320” having been calculated with respect to “Japanese restaurant A” is displayed under the image IM1 showing “Japanese restaurant A”. In addition, a subscore “90” related to the attribute information “time of day” and a subscore “50” related to the attribute information “location” are displayed in parallel to the accuracy score. In other words, a score SC1 reading “320/90/50” is displayed below the image IM1.

An accuracy score “215” having been calculated with respect to “Seafood restaurant C” is displayed under the image IM2 showing “Seafood restaurant C”. In addition, a subscore “50” related to the attribute information “time of day” and a subscore “100” related to the attribute information “location” are displayed in parallel to the accuracy score. In other words, a score SC2 reading “215/50/100” is displayed below the image IM2.

An accuracy score “354” having been calculated with respect to “Japanese restaurant E” is displayed under the image IM3 showing “Japanese restaurant E”. In addition, a subscore “70” related to the attribute information “time of day” and a subscore “85” related to the attribute information “location” are displayed in parallel to the accuracy score. In other words, a score SC3 reading “354/70/85” is displayed below the image IM3.

In this manner, by at least displaying an accuracy score, when there are a plurality of candidates of search results, the user can recognize which candidate was determined to have a high accuracy. In addition, providing numerical values instead of texts enables a display space to be downsized and even a small display 16 can be accommodated.

It should be noted that the designation with respect to the plurality of candidates may be performed by a pointing cursor as shown in FIG. 7, by designating an object name such as “Japanese restaurant A” by speech, or by designating a display position by speech. In addition, when designating “Japanese restaurant A”, a selection of a candidate may be performed by designating an accuracy score by speech such as “a restaurant with the score 320”. A selection of a candidate may be performed by designating a subscore by speech.

Display may be modified in accordance with an accuracy score. For example, display size may be increased in an ascending order of accuracy scores. In the example shown in FIG. 7, the image IM3 is displayed in a largest size, the image IM1 is displayed in a next-largest size, and the image IM2 is displayed in a smallest size. An order, a grayscale, a frame color, or the like of display of each of the images IM1 to IM3 may be modified in accordance with a magnitude of the accuracy score. For example, an order of display or the like is appropriately set so that an image with a high accuracy score becomes prominent. The images IM1 to IM3 may be displayed by combining these methods of modifying display. In addition, an upper limit value or a lower limit value of accuracy scores to be displayed, the number of subscores to be displayed, and the like may be set in accordance with the display space.

As shown in FIG. 7, in the present embodiment, at least one subscore is to be displayed in addition to an accuracy score. However, not all subscores are to be displayed, but only a portion thereof is to be displayed. According to the display, when a plurality of candidates are to be displayed, a decline in visibility due to a large number of subscores being displayed can be prevented. On the other hand, there may be cases where attribute information corresponding to a displayed subscore differs from attribute information intended by the user U. Therefore, in the present embodiment, switching of display of a subscore to another display is further enabled.

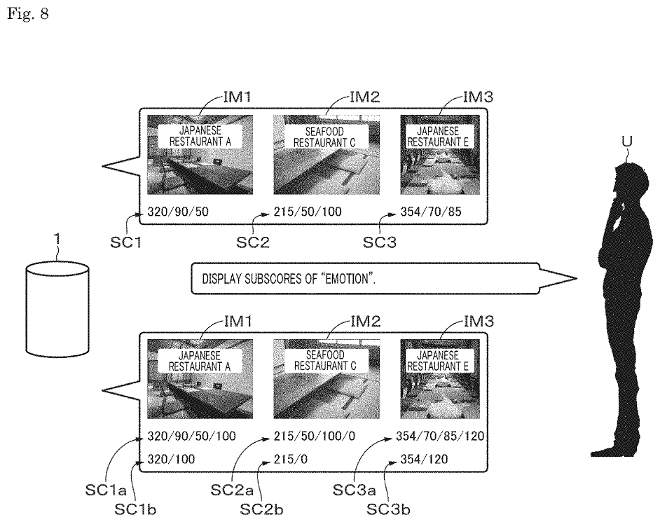

Switching of the display of a subscore to another display will be described with reference to FIG. 8. As described above, it is assumed that the images IM1 to IM3 are displayed on the display 16 of the agent 1. In this case, it is assumed that the user U utters “Display subscores of “emotion””. The utterance information of the user U is supplied to the control unit 10 via the speech input/output unit 15 and speech recognition by the control unit 10 is performed. The control unit 10 searches the database 17 and reads subscores respectively corresponding to the images IM1 to IM3 or, in other words, the IDs: 1, 4, and 7. In addition, as shown in FIG. 8, the control unit 10 displays a subscore of “emotion” below each image. Specifically, a score SC1a reading “320/90/50/100” to which a subscore of “emotion” has been added is displayed below the image IM1. A score SC2a reading “215/50/100/0” to which a subscore of “emotion” has been added is displayed below the image IM2. A score SC3a reading “354/70/85/120” to which a subscore of “emotion” has been added is displayed below the image IM3.

According to the display, the user U can find out subscores corresponding to desired attribute information. It should be noted that, as shown in FIG. 8, scores SC1b to SC3b that only include an accuracy score and a subscore corresponding to designated attribute information may be displayed. In addition, a subscore corresponding to designated attribute information may be highlighted and displayed so that the user U can better recognize the subscore. For example, a color of a subscore corresponding to the designated attribute information may be distinguished from a color of other subscores or the subscore corresponding to the designated attribute information may be caused to blink. Furthermore, when predetermined attribute information is designated by an utterance, when a subscore corresponding to the attribute information is already being displayed, the subscore may be highlighted and displayed in accordance with the utterance.

There may be cases where the user U is not satisfied or feels a sense of discomfort with respect to a displayed search result. For example, in the example shown in FIG. 8, there may be a case where the user U feels that a difference between the accuracy score of “Japanese restaurant E” and the accuracy score of “Japanese restaurant A” is not as large as expected despite the user U recalling that he/she had felt the food at “Japanese restaurant E” was delicious. In order to accommodate such cases, in the present embodiment, a weight for calculating an accuracy score can be changed by the user U by designating attribute information to be emphasized. More specifically, an accuracy score is recalculated by giving additional weight (increasing a weight) of a subscore that corresponds to attribute information that the user U desires to emphasize.

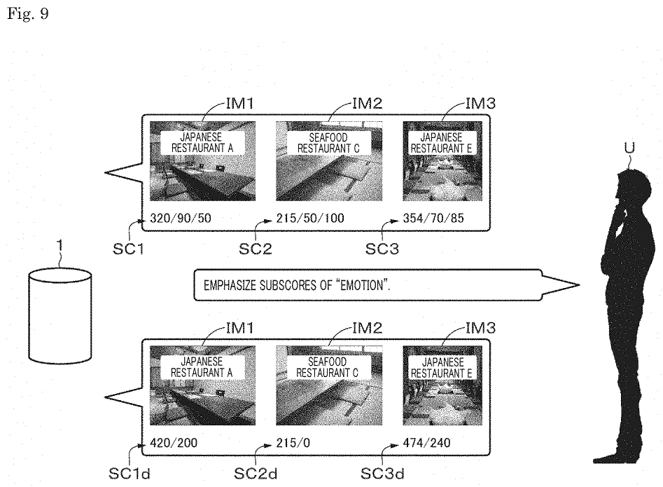

A specific example will be described with reference to FIG. 9. Let us assume that the user U having viewed the images IM1 to IM3 utters “Emphasize subscore of “emotion””. The utterance information of the user U is input to the control unit 10 via the speech input/output unit 15 and speech recognition by the control unit 10 is performed. The score calculation unit 10b of the control unit 10 recalculates an accuracy score by, for example, doubling a weight with respect to a subscore of “emotion” that is the designated attribute information.

In addition, as shown in FIG. 9, a recalculated accuracy score and subscores recalculated in accordance with the changed weight are displayed on the display 16 as scores SC1d to SC3d. Specifically, the subscore of “emotion” of “Japanese restaurant A” that was originally “100” is recalculated as “200”. The accuracy score of “Japanese restaurant A” becomes “420” that represents an increase by an amount of increase (100) of the subscore. “420/200” that represents the accuracy score and the subscore of “emotion” is displayed below the image IM1 as the score SC1d. The subscore of “emotion” of “Seafood restaurant C” that was originally “0” is also recalculated as “0”. Therefore, “215/0” that represents the accuracy score and the subscore of “emotion” of “Seafood restaurant C” which are unchanged is displayed below the image IM2 as the score SC2d. The subscore of “emotion” of “Japanese restaurant E” that was originally “120” is recalculated as “240”. The accuracy score of “Japanese restaurant E” becomes “474” that represents an increase by an amount of increase (120) of the subscore. “474/240” that represents the accuracy score and the subscore of “emotion” is displayed below the image IM3 as the score SC3d. The user U having viewed the accuracy scores and the subscores after the recalculations can recognize that the difference in accuracy scores between “Japanese restaurant A” and “Japanese restaurant E” has increased and can experience a sense of satisfaction in the fact that the user U had previously felt the food at “Japanese restaurant E” was delicious.

### Pattern P3: Output Example of Plurality of Search Results by Speech

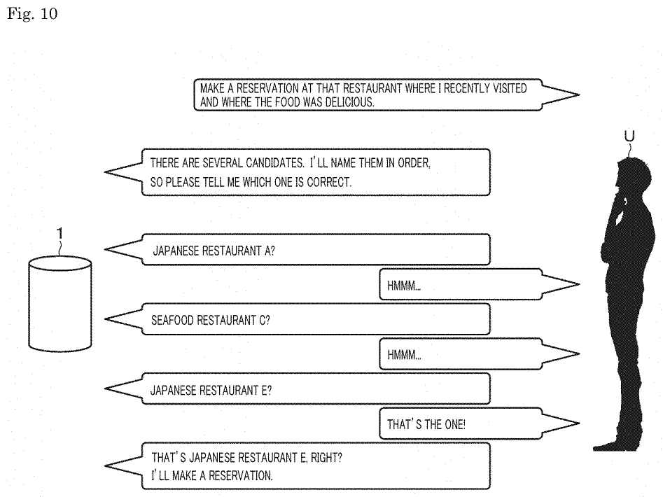

Next, an output example of a plurality of search results by speech will be described. FIG. 10 is a diagram for explaining an output example of a plurality of search results by speech. An utterance including a term with ambiguity is made by the user U. For example, the user U utters “Make a reservation at that restaurant where I recently visited and where the food was delicious”. The control unit 10 to which utterance information is input generates, in correspondence to the utterance information, speech data of a plurality of candidates and reproduces the speech data from the speech input/output unit 15.

For example, the plurality of candidates that are search results are sequentially reproduced as speech. In the example shown in FIG. 10, candidates are notified by speech in an order of “Japanese restaurant A”, “Seafood restaurant C”, and “Japanese restaurant E”. In this case, the speech corresponding to each restaurant name is an example of a piece of information corresponding to the predetermined term. In addition, “Japanese restaurant E” is selected by a response (for example, a designation by speech saying “That's the one”) by the user U upon being notified of “Japanese restaurant E”, and reservation processing of “Japanese restaurant E” by the agent 1 is performed.

When notifying a plurality of candidates by speech, the candidates may be notified in a descending order of accuracy scores. In addition, when notifying a plurality of candidates by speech, accuracy scores and subscores may be successively notified together with candidate names. Since there is a risk that numerical values such as accuracy scores alone may be missed by the user U, when reading out accuracy scores and the like, a sound effect, BGM (Background Music), or the like may be added. While types of sound effects and the like can be set as appropriate, for example, when an accuracy score is high, a happy sound effect is reproduced when reproducing a candidate name corresponding to the accuracy score, and when an accuracy score is low, a gloomy sound effect is reproduced when reproducing a candidate name corresponding to the accuracy score.

### Pattern P4

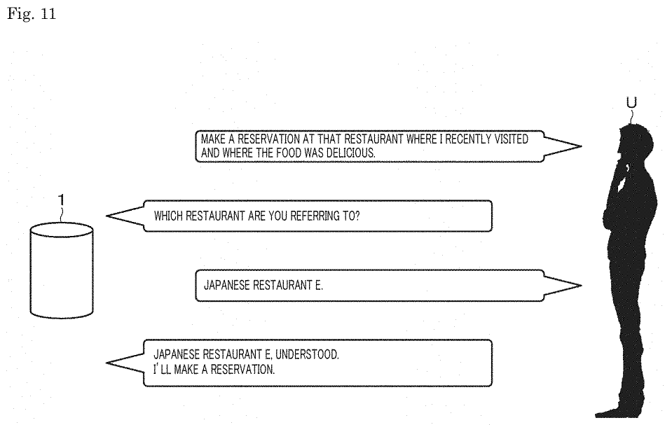

The pattern P4 is an output pattern of a search result that is performed when there are no accuracy scores that satisfy a criterion to begin with. In this case, the agent 1 makes a direct query to the user regarding contents. FIG. 11 is a diagram showing an example of communication that takes place between the user U and the agent 1 in the case of the pattern P4.

The user U makes an utterance (for example, “Make a reservation at that restaurant where I recently visited and where the food was delicious”) that includes a term with ambiguity. When a search of the database 17 in accordance with the utterance information results in no appropriate candidates, for example, the agent 1 outputs speech saying “Which restaurant are you referring to?” to directly query the user U about a specific restaurant name.

Let us assume that the user U responds by saying “Japanese restaurant E” to the query by the agent 1. In accordance with the response, the agent 1 executes processing for making a reservation at Japanese restaurant E.

As described above, search results are output from the agent 1 based on the exemplified patterns P1 to P4. When outputting the search results, a method using video and a method using speech may be used in combination. In addition, when outputting search results according to the patterns P1, P2, and P4, video may be used or a method that concomitantly uses video and speech may be used.

### Flow of Processing

A flow of processing performed by the agent 1 according to the first embodiment will be described. Control related to the processing described below is performed by the control unit 10 unless specifically stated to the contrary.

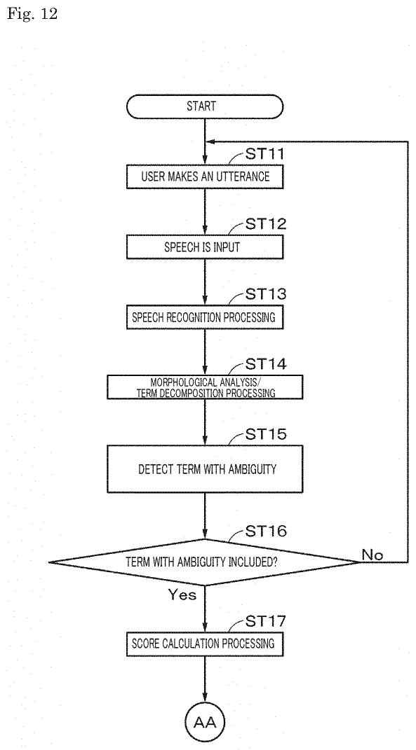

FIG. 12 is a flow chart showing a flow of processing mainly performed by the score calculation unit 10b of the control unit 10. In step ST11, the user makes an utterance. In following step ST12, speech accompanying the utterance is input as utterance information to the control unit 10 via the speech input/output unit 15. Subsequently, the processing advances to step ST13.

In step ST13 and steps ST14 and ST15 subsequent thereto, the control unit 10 executes speech processing such as speech recognition, morphological analysis, and word decomposition with respect to the utterance information and detects a term (word) with ambiguity. Subsequently, the processing advances to step ST16.

In step ST16, as a result of processing of steps ST13 to ST15, a determination is made as to whether or not the utterance information of the user includes a term with ambiguity. When the utterance information does not include a term with ambiguity, the processing returns to step ST11. When the utterance information includes a term with ambiguity, the processing advances to step ST17.

In step ST17, the score calculation unit 10b of the control unit 10 performs score calculation processing. Specifically, the score calculation unit 10b of the control unit 10 calculates subscores corresponding to the utterance information. In addition, the score calculation unit 10b of the control unit 10 calculates an accuracy score based on the calculated subscores.

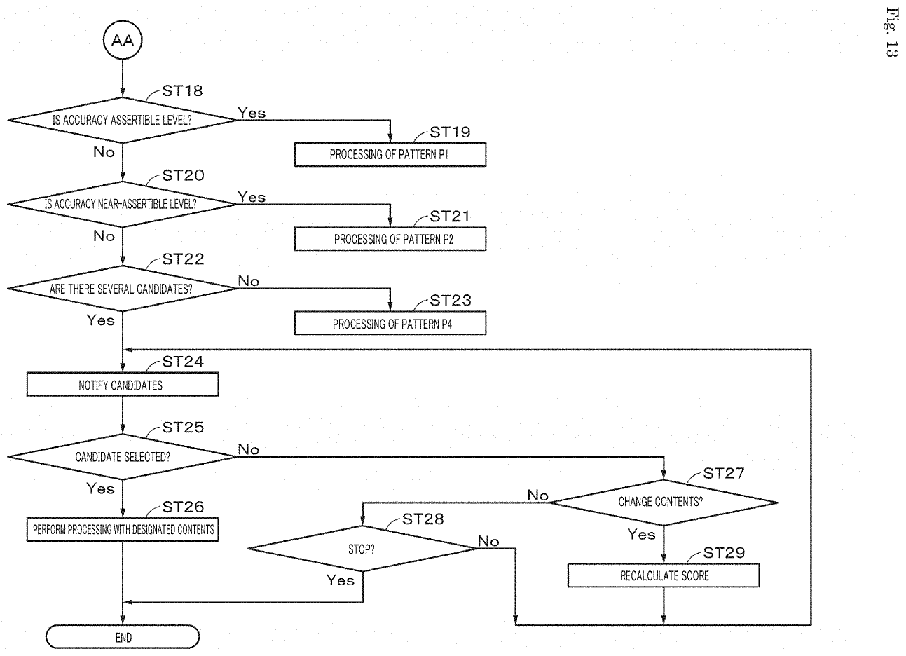

Following the processing shown in the flow chart in FIG. 12, processing shown in the flow chart in FIG. 13 is performed. It should be noted that a description of “AA” shown in the flow charts in FIGS. 12 and 13 indicates continuity of processing and does not indicate a specific processing step.

The processing shown in the flow chart in FIG. 13 is processing that is mainly performed by the search result output unit 10c of the control unit 10. In step ST18, a determination is made as to whether or not there is only one candidate corresponding to the utterance information and that the candidate is at a level (hereinafter, referred to as an assertible level when appropriate) where it can be asserted that the candidate corresponds to the utterance by the user. When accuracy of the search result is at the assertible level (for example, an accuracy of around 99%), the processing advances to step ST19.

In step ST19, the candidate that is a search result is notified by the pattern P1 described above. For example, the control unit 10 performs processing based on the utterance of the user made in step ST11 while notifying a candidate name of the one and only candidate.

When accuracy of the search result is not at the assertible level, the processing advances to step ST20. In step ST20, a determination is made as to whether or not there is only one candidate corresponding to the utterance information and that the candidate is at a level (hereinafter, referred to as a near-assertible level when appropriate) where it can be nearly asserted that the candidate corresponds to the utterance by the user. When accuracy of the search result is at the near-assertible level (for example, an accuracy of around 90%), the processing advances to step ST21.

In step ST21, the candidate that is a search result is notified by the pattern P2 described above. For example, the control unit 10 notifies a candidate name of the one and only candidate and, when it is confirmed that the candidate name is a candidate desired by the user, the control unit 10 performs processing based on the utterance of the user made in step ST11.

When accuracy of the search result is not at the near-assertible level, the processing advances to step ST22. In step ST22, a determination is made as to whether or not there are several candidates that are search results. When there are no candidates corresponding to the utterance information, the processing advances to step ST23.

In step ST23, processing corresponding to the pattern P4 described above is executed. In other words, processing in which the agent 1 directly queries the user about a name of the candidate is performed.

In step ST22, when there are several candidates that are search results, the processing advances to step ST24. In step ST24, processing corresponding to the pattern P3 described above is executed and the user is notified of a plurality of candidates that are search results. The plurality of candidates may be notified by speech, notified by video, or notified by a combination of speech and video. Subsequently, the processing advances to step ST25.

In step ST25, a determination is made as to whether or not any of the plurality of notified candidates has been selected. The selection of a candidate may be performed by speech, by an input using the operation input unit 13, or the like. When any of the candidates has been selected, the processing advances to step ST26.

In step ST26, the control unit 10 executes processing of contents indicated in the utterance of the user with respect to the selected candidate. Subsequently, the processing is ended.

In step ST25, when any of the plurality of notified candidates has not been selected, the processing advances to step ST27. In step ST27, a determination is made as to whether or not there is an instruction to change contents. An instruction to change contents is, for example, an instruction to change a weight of each piece of attribute information or, more specifically, an instruction to place emphasis on a predetermined piece of attribute information. In step ST27, when there is no instruction to change contents, the processing advances to step ST28.

In step ST28, a determination is made as to whether or not an instruction to stop (abort) the series of processing steps has been issued by the user. When an instruction to stop the series of processing steps has been issued, the processing is ended. When an instruction to stop the series of processing steps has not been issued, the processing returns to step ST24 and notification of candidates is continued.

In step ST27, when there is an instruction to change contents, the processing advances to step ST29. In step ST29, an accuracy score and subscores are recalculated in accordance with the instruction issued in step ST27. The processing then advances to step ST24 and a notification based on the accuracy score and the subscores after the recalculation is performed.

As described above, according to the present embodiment, based on an objective index (for example, an accuracy score), the user can understand how the agent had determined a term with ambiguity. In addition, the user can change contents of attribute information corresponding to an index (for example, a subscore). Furthermore, since the agent can make determinations based on storage of previous words, an accuracy of determinations by the agent is improved. In addition, also importing biological information, camera video, and the like instead of just importing words enables the agent to make determinations with higher accuracy. Furthermore, an improvement in the determination accuracy of the agent makes interactions between the agent and the user (a person) more natural and prevents the user from feeling a sense of discomfort.

### Second Embodiment

Next, a second embodiment will be described. In the following description, components that are the same or homogeneous to those of the first embodiment are assigned same reference signs and redundant descriptions will be omitted. In addition, matters described in the first embodiment can also be applied to the second embodiment unless specifically stated to the contrary.

The second embodiment represents an example of applying an agent to a mobile body or, more specifically, to a vehicle-mounted apparatus. While the mobile body will be described as a vehicle in the present embodiment, the mobile body may be anything such as a train, a bicycle, or an aircraft.

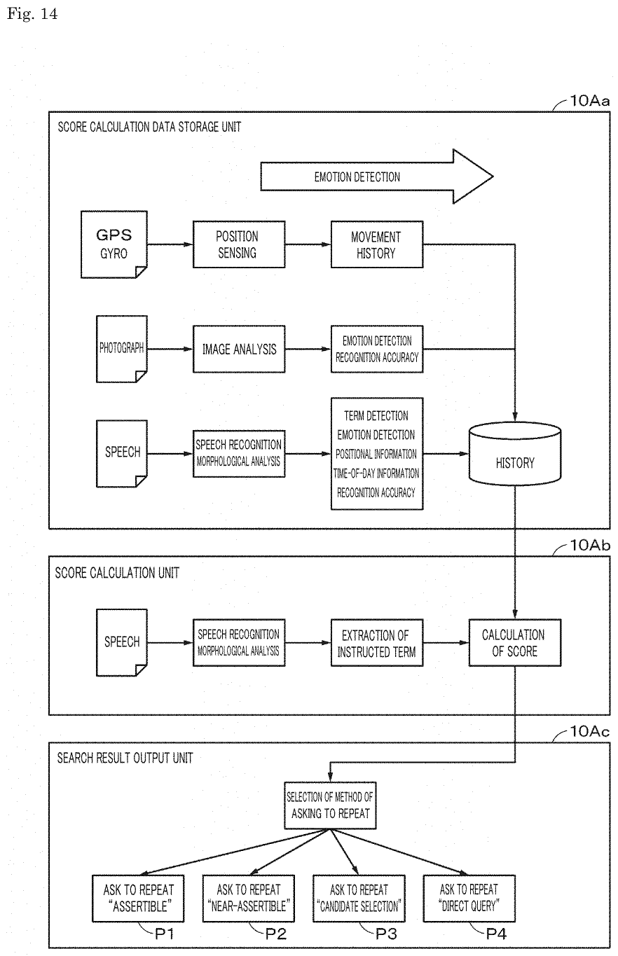

An agent (hereinafter, referred to as an agent 1A when appropriate) according to the second embodiment has a control unit 10A that offers similar functionality to the control unit 10 of the agent 1. As shown in FIG. 14, as functions thereof, for example, the control unit 10A has a score calculation data storage unit 10Aa, a score calculation unit 10Ab, and a search result output unit 10Ac. The control unit 10A differs from the control unit 10 in terms of architecture in the score calculation data storage unit 10Aa. The agent 1A applied to a vehicle-mounted apparatus performs position sensing using a GPS, a gyroscope sensor, or the like and stores a result thereof in the database 17 as movement history. The movement history is stored as time-series data. In addition, terms (words) included in utterances made in the vehicle are also stored.

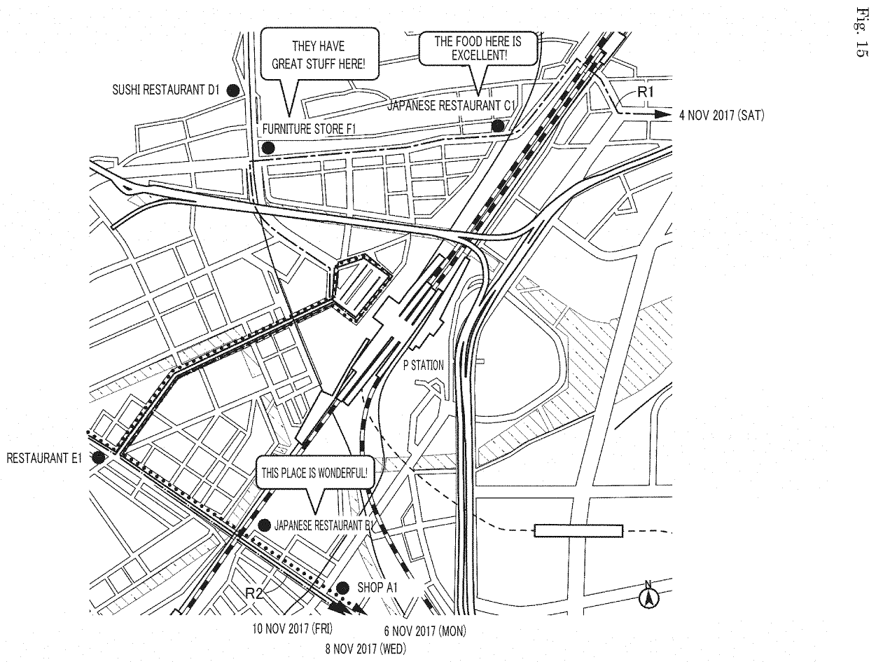

FIG. 15 is a diagram (a map) to be referred to for explaining a specific example of information stored in the database 17 according to the second embodiment. For example, a route R1 traveled on 4 Nov. 2017 (Sat) is stored in the database 17 as movement history. “Japanese restaurant C1” and “Furniture store F1” exist at predetermined positions along the route R1 and Sushi restaurant D1 exists at a location that is slightly distant from the route R1. An utterance made near “Japanese restaurant C1” (for example, an utterance saying that “the food here is excellent”) or an utterance made when traveling near “Furniture store F1” (for example, an utterance saying that “they have great stuff here”) are also stored in the database 17.

In addition, for example, a route R2 traveled on 6 Nov. 2017 (Mon), 8 Nov. 2017 (Wed), and 10 Nov. 2017 (Fri) is stored in the database 17 as movement history. “Shop A1”, “Japanese restaurant B1”, and “Japanese restaurant E1” exist at predetermined positions along the route R2. An utterance made when traveling near “Japanese restaurant B1” (for example, an utterance saying that “this place is wonderful”) is also stored in the database 17. In addition, names of stores or restaurants that exist along each route or exist within a predetermined range from each route are registered in the database 17 as terms. The terms in this case may be based on utterances or may be read from map data.

In a state where the exemplified information is stored in the database 17, for example, an utterance saying “Please make a reservation at that Japanese restaurant near P Station which I pass on weekdays” is made by the user with respect to the agent 1A. Since the utterance information includes the term “that” which has ambiguity, the control unit 10A of the agent 1A calculates a subscore for each piece of attribute information corresponding to the term and calculates an accuracy score based on the calculated subscores in a similar manner to the first embodiment.

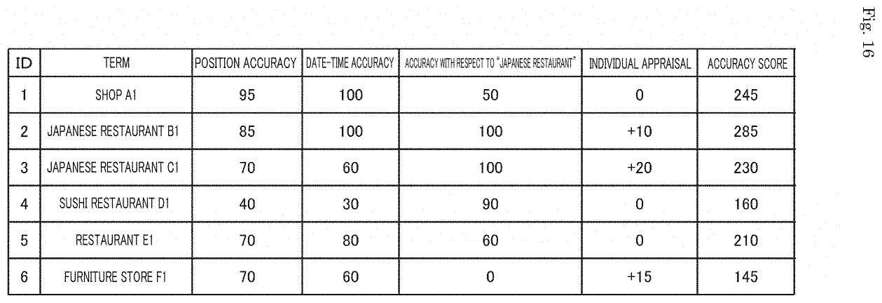

FIG. 16 shows an example of calculated accuracy scores and subscores. As attribute information, for example, an “ID”, a “position accuracy”, a “date-time accuracy”, an “accuracy with respect to Japanese restaurant”, and an “individual appraisal” are associated with each term.

Hereinafter, settings related to the calculation of subscores will be described.

Position accuracy: Since the utterance information includes a term reading “near P Station”, a subscore is calculated so that the shorter the distance to P Station, the higher the subscore.

Date-time accuracy: Since the utterance information includes a word reading “weekdays”, a subscore is calculated so that a subscore of a restaurant that exists along the route R2 which is frequently traveled on weekdays is high and a subscore of a restaurant that exists along the route R1 which is traveled on weekends and holidays is low.

Accuracy with respect to “Japanese restaurant”: Since the utterance information includes a word reading “that Japanese restaurant”, a subscore is calculated so that a restaurant that fits the description of a Japanese restaurant is given a higher subscore.

Individual appraisal: This is an appraised value that is derived from previously-stored utterances made inside the vehicle. The more positive the utterances, the higher the subscore.

Subscores calculated based on the settings described above are shown in FIG. 16. In addition, a value representing a sum of the subscores is calculated as an accuracy score. It should be noted that the accuracy score may be calculated by a weighted addition of the respective subscores in a similar manner to the first embodiment.

Notification of a candidate with respect to the user is performed based on an accuracy score calculated as described above. The notification of a candidate is performed based on any of the patterns P1 to P4 in a similar manner to the first embodiment. For example, in the case of the pattern P3 in which a plurality of candidates are notified as search results, notification is performed by making at least accuracy scores recognizable. Notification may be performed by making subscores recognizable or by making subscores instructed by the user recognizable as described in the first embodiment.

When the agent 1A is applied as a vehicle-mounted apparatus, the following processing may be performed during a response from the agent 1A with respect to the user.

When a query is made by the user with respect to the agent 1A while driving a vehicle, a response by the agent 1A (including notification of a plurality of candidates) may be made after detecting that the vehicle has stopped. In the case of video, a video is displayed after the vehicle stops and, also in the case of speech, speech of the response is similarly provided after the vehicle stops. Accordingly, a decline in concentration of the user toward driving can be prevented. It should be noted that the agent 1A can determine whether or not the vehicle has stopped based on sensor information obtained by a vehicle speed sensor. In this configuration, the sensor unit 11 includes the vehicle speed sensor.

In addition, when the agent 1A detects that the vehicle has started moving during notification by video or speech, the agent 1A suspends the notification by video or speech. Furthermore, based on sensor information of the vehicle speed sensor, when a vehicle speed of a certain level or higher continues for a certain period or longer, the agent 1A determines that the vehicle is being driven on an expressway. When it is expected that the vehicle will not stop for a certain period or longer after a query is made from the user with respect to the agent 1A such as when driving on an expressway as described above, the query may be canceled. The fact that the query has been canceled, an error message, or the like may be notified to the user by speech or the like. Responses may be provided to queries made by a user seated on a passenger seat with respect to the agent 1A. Enabling the agent 1A to accept only input from a user seated on a passenger seat can be realized by applying, for example, a technique referred to as beam-forming.

The second embodiment described above can also produce an effect similar to that of the first embodiment.

### Third Embodiment

Next, a third embodiment will be described. In the following description, components that are the same or homogeneous to those of the first and second embodiments are assigned same reference signs and redundant descriptions will be omitted. In addition, matters described in the first and second embodiments can also be applied to the third embodiment unless specifically stated to the contrary. The third embodiment represents an example of applying an agent to a home electrical appliance or, more specifically, to a refrigerator.

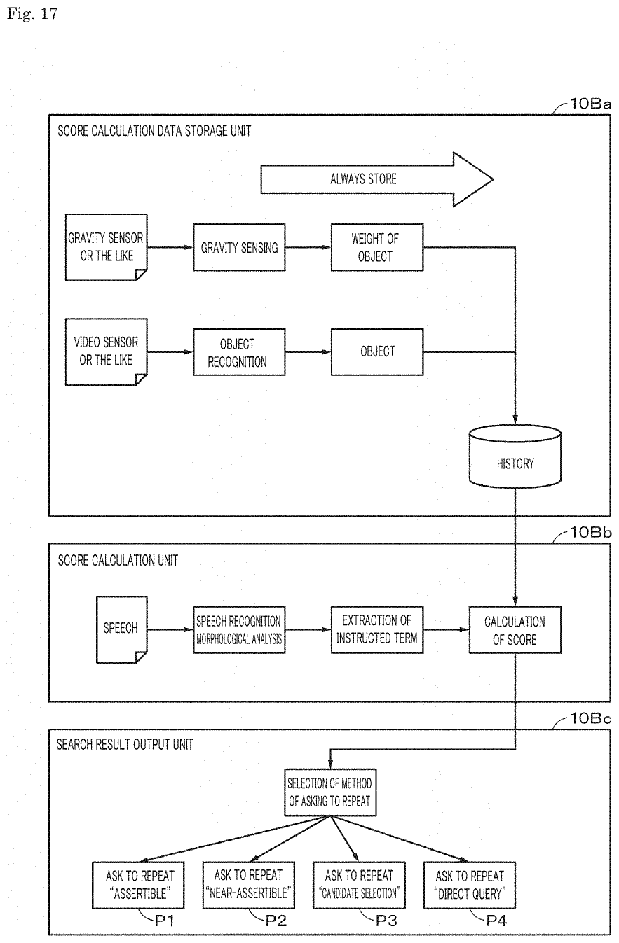

An agent (hereinafter, referred to as an agent 1B when appropriate) according to the third embodiment has a control unit 10B that offers similar functionality to the control unit 10 of the agent 1. As shown in FIG. 17, as functions thereof, for example, the control unit 10B has a score calculation data storage unit 10Ba, a score calculation unit 10Bb, and a search result output unit 10Bc.

The control unit 10B differs from the control unit 10 in terms of architecture in the score calculation data storage unit 10Ba. The agent 1B includes, for example, two systems of sensors as the sensor unit 11. One of the sensors is “a sensor for recognizing objects” of which examples include an imaging apparatus and an infrared sensor. The other sensor is “a sensor for measuring weight” of which examples include a gravity sensor. Using sensing results of the two systems, the score calculation data storage unit 10Ba stores data regarding types and weights of objects inside the refrigerator.

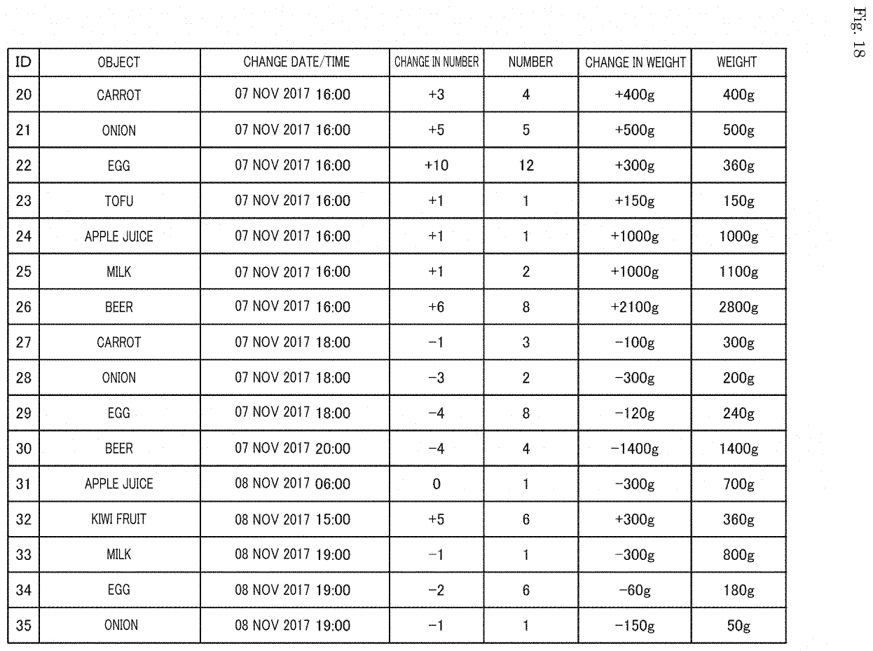

FIG. 18 shows an example of information stored in the database 17 by the score calculation data storage unit 10Ba. An “object” in FIG. 18 corresponds to an “object” in the refrigerator that has been sensed by video sensing. A “change date/time” represents a date and time at which a change accompanying an object placed inside or taken out from the refrigerator had occurred. With respect to time information, a configuration in which a time measuring unit is included in the sensor unit 11 may be adopted, in which case time information may be obtained by the control unit 10B from the time measuring unit, or the control unit 10B may obtain time information from an RTC (Real Time Clock) included in the control unit 10B itself.

“Change in number/number” represent the number of the object inside the refrigerator that had changed at the change date/time described above, and the number of the object after the change. The change in number is obtained based on, for example, a sensing result by an imaging apparatus or the like. “Change in weight/weight” represent a weight (an amount) that had changed at the change date/time described above, and the weight after the change. It should be noted that, in some cases, the weight changes even though the number does not. For example, there are cases where the weight changes even though the number does not such as the case of “apple juice” indicated by ID: 24 and ID: 31 in FIG. 18. This indicates that apple juice has been consumed.

Let us now consider a case where, for example, the user asks the agent 1B, “What was the vegetable that's about to run out?” Such thinking for checking necessities often takes place during shopping outside of the home. Therefore, the user may talk to a smart phone during shopping outside of the home and utterance information may be transmitted from the smart phone to the agent 1B via a network. A response to the user's query is transmitted from the agent 1B via the network and the response is notified by display, speech, or the like from the user's smart phone. It is needless to say that, given the increasing popularity in recent years of shopping using the Internet or the like, cases where thinking for checking necessities takes place indoors (inside the home) are also expected. In such a case, a query by the user may be directly input to the agent 1B.

The agent 1B performs speech recognition with respect to the input utterance information of the user. Since the utterance information includes a term with ambiguity, “that vegetable”, the control unit 10B calculates an accuracy score and subscores.

First, the score calculation unit 10Bb of the control unit 10B reads, from information in the database 17 shown in FIG. 18, a latest (newest) change date/time and a change in the number or the change in the weight that had occurred at the change date/time of each “object”. In addition, based on the read result, the score calculation unit 10Bb calculates an accuracy score and subscores for each “object”.

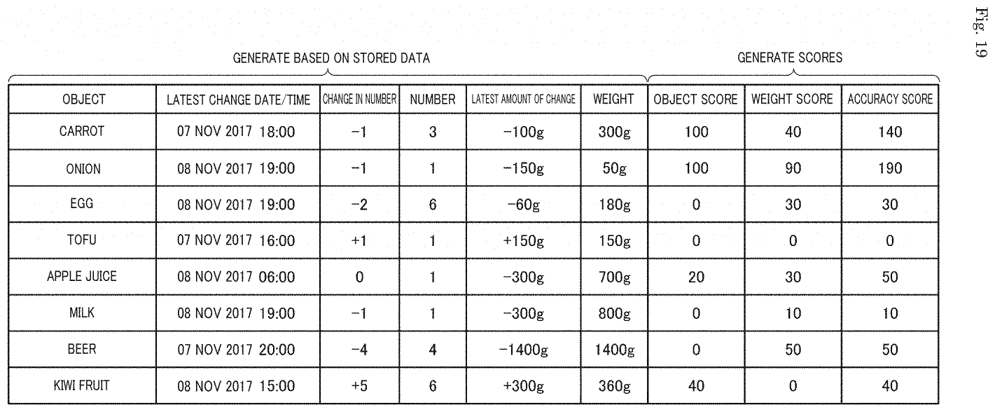

FIG. 19 shows an example of calculated accuracy scores and subscores. In the present embodiment, an “object score” and a “weight score” are set as subscores. It is needless to say that scores in accordance with recognition accuracy of an object or the like may also be provided as described in the first embodiment.

Hereinafter, settings related to each subscore will be described.

Object score: Since the utterance information includes the term “that vegetable”, a high score is given in the case of a vegetable and a certain score is also given in the case of a fruit. In the example shown in FIG. 19, for example, carrots and onions which are vegetables are given high scores and kiwi fruit is also given a certain score. Conversely, scores given to non-vegetables (for example, eggs) are low.

Weight score: A score determined based on a most recent amount of change and a present weight is given. Since the utterance information includes the term (sentence) “about to run out”, a higher score is given when the amount of change is “negative (−)” and the weight after the change is smaller. For example, a high score is given to onions of which the amount of change is “negative (−)” and the weight after the change is small.

An accuracy score is calculated based on the calculated subscores. In the example shown in FIG. 19, an accuracy score is calculated by adding up the respective subscores. It is needless to say that the accuracy score may be calculated by a weighted addition of the respective subscores.

Notification of a candidate with respect to the user is performed based on an accuracy score calculated as described above. The notification of a candidate is performed based on any of the patterns P1 to P4 in a similar manner to the first embodiment. For example, in the case of the pattern P3 in which a plurality of candidates are notified as search results, notification is performed by making at least accuracy scores recognizable. Notification may be performed by making subscores recognizable or by making subscores instructed by the user recognizable as described in the first embodiment.

The third embodiment described above can also produce an effect similar to that of the first embodiment.

### Modifications

While a plurality of embodiments of the present disclosure have been described with specificity above, it is to be understood that the contents of the present disclosure are not limited to the embodiments described above and that various modifications can be made based on the technical ideas of the present disclosure. Hereinafter, modifications will be described.

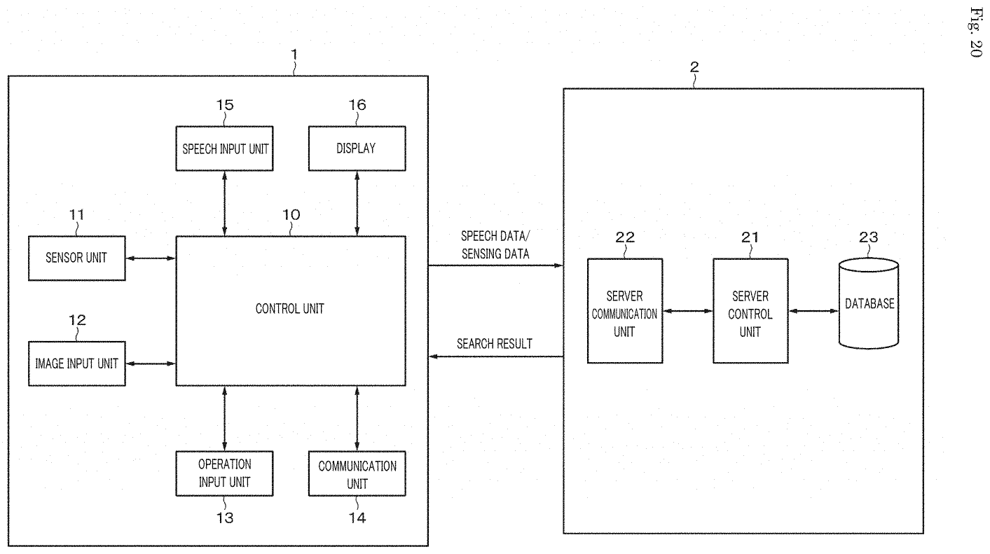

A part of the processing by the agent according to the embodiments described above may be performed by a server apparatus. For example, as shown in FIG. 20, communication is performed between an agent 1 and a server apparatus 2. The server apparatus 2 has, for example, a server control unit 21, a server communication unit 22, and a database 23.

The server control unit 21 controls respective units of the server apparatus 2. For example, the server control unit 21 has the score calculation data storage unit 10a and the score calculation unit 10b described earlier. The server communication unit 22 is a component for communicating with the agent 1 and has components such as a modulation/demodulation circuit and an antenna which correspond to a communication standard. The database 23 stores similar information to the database 17.

Speech data and sensing data are transmitted from the agent 1 to the server apparatus 2. The speech data and the like are supplied to the server control unit 21 via the server communication unit 22. The server control unit 21 stores data for score calculation in the database 23 in a similar manner to the control unit 10. In addition, when speech data supplied from the agent 1 includes a term with ambiguity, the server control unit 21 calculates an accuracy score and the like and transmits a search result corresponding to utterance information of the user to the agent 1. The agent 1 notifies the user of the search result by any of the patterns P1 to P4 described earlier. Alternatively, a notification pattern may be designated by the server apparatus 2. In this case, the designated notification pattern is described in data transmitted from the server apparatus 2 to the agent 1.

Other modifications will now be described. In the embodiments described above, speech to be input to the agent is not limited to a conversation taking place around the agent but may also include a conversation recorded outside the home or the like, a conversion over the phone, and the like.

In the embodiments described above, a position where an accuracy score and the like are displayed is not limited to below an image and may be changed as appropriate such as to on top of an image.

In the embodiments described above, processing corresponding to utterance information is not limited to making a reservation at a restaurant and may be any kind of processing such as purchasing an item or reserving a ticket.

In the third embodiment described above, a sensor that reads a use-by date of an object (for example, a sensor that reads an RFID (Radio Frequency Identifier) attached to the object) may be applied as the sensor unit, in which case a weight may be set to 0 when the use-by date expires. In this manner, a configuration of the sensor unit may be changed as appropriate.

Configurations presented in the embodiments described above are merely examples and are not limited thereto. It is needless to say that components may be added, deleted, and the like without departing from the spirit and the scope of the present disclosure. The present disclosure can also be realized in any form such as an apparatus, a method, a program, and a system. The program may be stored in, for example, a memory included in the control unit or a suitable storage medium.

The present disclosure can also adopt the following configurations.

(1)

An information processing apparatus, including:

a control unit configured to perform, when there are a plurality of pieces of information corresponding to a predetermined term having been associated with a plurality of pieces of attribute information as candidates of a search result, control to notify each piece of information by making an index calculated with respect to each term recognizable.

(2)

The information processing apparatus according to (1), wherein the attribute information includes positional information acquired based on utterance information.

(3)

The information processing apparatus according to (1) or (2), wherein the control unit is configured to notify the search result when utterance information including a term with ambiguity is input.

(4)

The information processing apparatus according to any one of (1) to (3), wherein

the index includes a subscore calculated for each piece of attribute information and an integrated score that integrates a plurality of subscores, and

the control unit is configured to notify at least the integrated score so as to be recognizable.

(5)

The information processing apparatus according to (4), wherein the integrated score is a weighted addition of the subscores.

(6)

The information processing apparatus according to (5), wherein the control unit is configured to change a weight used in the weighted addition in accordance with utterance information.

(7)

The information processing apparatus according to any one of (4) to (6), wherein

the control unit is configured to notify at least one subscore so as to be recognizable.

(8)

The information processing apparatus according to any one of (1) to (7), wherein

the control unit is configured to display a plurality of pieces of the information in association with the index corresponding to each piece of information.

(9)

The information processing apparatus according to (8), wherein

the control unit is configured to differently display at least one of a size, a grayscale, and an arrangement order of display of each piece of information in accordance with an index corresponding to the piece of information.

(10)

The information processing apparatus according to (8), wherein

the index includes a subscore calculated for each piece of attribute information and an integrated score that integrates a plurality of subscores, and

the control unit is configured to display a subscore having been instructed by a predetermined input.

(11)

The information processing apparatus according to any one of (1) to (10), wherein

the control unit is configured to output a plurality of pieces of the information by speech in association with the index corresponding to each piece of information.

(12)

The information processing apparatus according to (11), wherein

the control unit is configured to consecutively output a predetermined piece of the information and the index corresponding to the piece of information.

(13)

The information processing apparatus according to (11), wherein

the control unit is configured to output a predetermined piece of the information by adding a sound effect based on the index corresponding to the piece of information.

(14)

The information processing apparatus according to any one of (1) to (13), wherein

the attribute information includes information related to an appraisal based on an utterance made during movement of a mobile body.

(15)

An information processing method, including:

a control unit performing, when there are a plurality of pieces of information corresponding to a predetermined term having been associated with a plurality of pieces of attribute information as candidates of a search result, control to notify each piece of information by making an index calculated with respect to each term recognizable.

(16)

A program that causes a computer to execute an information processing method including:

a control unit performing, when there are a plurality of pieces of information corresponding to a predetermined term having been associated with a plurality of pieces of attribute information as candidates of a search result, control to notify each piece of information by making an index calculated with respect to each term recognizable.

### REFERENCE SIGNS LIST

1, 1A, 1B Agent

10, 10A, 10B Control unit

11 Sensor unit

15 Speech input unit

16 Display

1. An information processing apparatus, comprising:
a control unit configured to perform, when there are a plurality of pieces of information corresponding to a predetermined term having been associated with a plurality of pieces of attribute information as candidates of a search result, control to notify each piece of information by making an index calculated with respect to each term recognizable.

2. The information processing apparatus according to claim 1, wherein
the attribute information includes positional information acquired based on utterance information.

3. The information processing apparatus according to claim 1, wherein
the control unit is configured to notify the search result when utterance information including a term with ambiguity is input.

4. The information processing apparatus according to claim 1, wherein
the index includes a subscore calculated for each piece of attribute information and an integrated score that integrates a plurality of subscores, and
the control unit is configured to notify at least the integrated score so as to be recognizable.

5. The information processing apparatus according to claim 4, wherein
the integrated score is a weighted addition of the subscores.

6. The information processing apparatus according to claim 5, wherein
the control unit is configured to change a weight used in the weighted addition in accordance with utterance information.

7. The information processing apparatus according to claim 4, wherein
the control unit is configured to notify at least one subscore so as to be recognizable.

8. The information processing apparatus according to claim 1, wherein
the control unit is configured to display a plurality of pieces of the information in association with the index corresponding to each piece of information.

9. The information processing apparatus according to claim 8, wherein
the control unit is configured to differently display at least one of a size, a grayscale, and an arrangement order of display of each piece of information in accordance with an index corresponding to the piece of information.

10. The information processing apparatus according to claim 8, wherein
the index includes a subscore calculated for each piece of attribute information and an integrated score that integrates a plurality of subscores, and
the control unit is configured to display a subscore having been instructed by a predetermined input.

11. The information processing apparatus according to claim 1, wherein
the control unit is configured to output a plurality of pieces of the information by speech in association with the index corresponding to each piece of information.

12. The information processing apparatus according to claim 11, wherein
the control unit is configured to consecutively output a predetermined piece of the information and the index corresponding to the piece of information.

13. The information processing apparatus according to claim 11, wherein
the control unit is configured to output a predetermined piece of the information by adding a sound effect based on the index corresponding to the piece of information.

14. The information processing apparatus according to claim 1, wherein
the attribute information includes information related to an appraisal based on an utterance made during movement of a mobile body.

15. An information processing method, comprising:
a control unit performing, when there are a plurality of pieces of information corresponding to a predetermined term having been associated with a plurality of pieces of attribute information as candidates of a search result, control to notify each piece of information by making an index calculated with respect to each term recognizable.

16. A program that causes a computer to execute an information processing method comprising:
a control unit performing, when there are a plurality of pieces of information corresponding to a predetermined term having been associated with a plurality of pieces of attribute information as candidates of a search result, control to notify each piece of information by making an index calculated with respect to each term recognizable.
